(19) United States
(12) Patent Application Publication
(10) Pub. No.: US 2010/0029189 A1
(43) Pub. Date: Feb. 4, 2010

(54) METHODS FOR STIFFENING THIN WALL DIRECT MANUFACTURED STRUCTURES

(76) Inventor: Jeffrey H. Wood, Eureka, MO (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 11/691,860

(22) Filed: Mar. 27, 2007

(51) Int. Cl. B64D 13/00; B29C 35/08

(52) U.S. Cl. 454/76; 264/497

(57) ABSTRACT

A method for manufacturing a wall of a thin-walled structure is described. The method includes receiving parameters for the wall and one or more stiffening features associated with the wall via a user interface, providing the parameters to a machine configured to fabricate the wall and incorporate the one or more stiffening features, the machine using a direct manufacturing process and operating the machine to integrally fabricate the wall and the one or more stiffening features.

### BACKGROUND OF THE INVENTION

This invention relates generally to manufacturing of composite structures, and more specifically, to methods for stiffening thin wall direct manufactured structures.

Certain composite structures, for example, aircraft structures or parts such as ductwork and air handling plenums, are typically fabricated from composite materials that can require tedious hand lay up procedures and complex tooling. In these composite structures, complex internal features, which are sometimes referred to as blind features, are typically avoided to maintain a capability for production. Maintaining an ease of production, however, limits the designs to shapes and features that are accessible for laying up the composite materials.

In composite structure production, the parts are typically configured with thickened walls to maintain stiffness from buckling and collapse. Any additional stiffening features, for example, angled clips or ribs, are attached as a secondary operation. Secondary operations add costs and increase part counts. Secondary operations and thickened walls also typically increase the weight of the parts.

### BRIEF DESCRIPTION OF THE INVENTION

A method for manufacturing a wall of a thin-walled structure is provided. The method includes receiving parameters for the wall and one or more stiffening features associated with the wall via a user interface, providing the parameters to a machine configured to fabricate the wall and incorporate the one or more stiffening features, the machine using a direct manufacturing process, and operating the machine to integrally fabricate the wall and the one or more stiffening features.

In another aspect, an air handling aerospace structure is provided that comprises a plurality of walls defining a chamber and at least one stiffening feature. The stiffening features are formed integrally with at least one of the walls. The walls and the stiffening features fabricated utilizing a direct manufacturing process.

In still another aspect, a method for direct manufacturing a structure having at least one substantially enclosed chamber defined by a plurality of walls is provided. The method includes defining, for input into the direct manufacturing process, the plurality of walls, a stiffening feature for at least one of the walls, and a remainder of the structure, and integrally forming the walls, any stiffening feature associated with each respective wall, and the remainder of the structure, with the direct manufacturing process.

### BRIEF DESCRIPTION OF THE DRAWINGS

FIG. 1 is an illustration of a system utilized in the direct manufacture of composite structures.

FIG. 2 is a cutaway view illustration of an air plenum fabricated utilizing the system of FIG. 1.

FIG. 3 is a perspective view of the air plenum of FIG. 2.

FIG. 4 is a cutaway view illustration of a baffled air plenum, portions of which are in a single opposing arch configuration.

FIG. 5 is a cross-sectional view of a portion of a wall of the air plenum of FIG. 4, illustrating the single opposing arch configuration.

FIG. 6 is a cutaway view illustration of another embodiment of air plenum, portions of which are in a double opposing arch configuration.

FIG. 7 is a cross-sectional view of a portion of a wall of the air plenum of FIG. 6 in a first direction.

### DETAILED DESCRIPTION OF THE INVENTION

Described herein are methods that fill the need for lightweight and inexpensive composite structures while also reducing the above described secondary operations. In practice, utilization of the described methods result in structures that possess relatively thin walls. These structures further include stiffening features, which may be formed integrally with the walls. Such a structure provides strengthened walls, which may be utilized instead of structures that include relatively thicker walls that are fabricated utilizing other composite fabrication methods. Such a structure also reduces secondary operations associated with current composite material structure production, such as inclusion of angled clips or ribs within the walls of the structure.

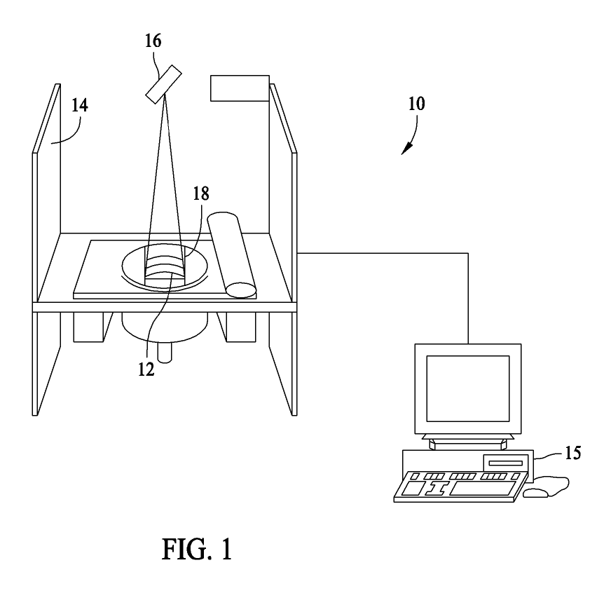

FIG. 1 is an illustration of a system 10 utilized in the direct manufacture of structures 12 in accordance with the methods described herein. In one embodiment, system 10 includes a direct manufacturing assembly 14, for example, a selective laser sintering assembly, to generate the desired structure (or structures) 12 in a single build run which is controlled utilizing a computer assembly 15. At least in the selective laser sintering example, direct manufacturing assembly 14 incorporates a laser 16 to integrally fabricate solid structures within a build chamber 18 during the build run.

Selective laser sintering (SLS) is a process for generating a material from a powdered sintering compound, and is one type of direct manufacturing process. In the SLS process, the powdered compound is distributed onto a surface within build chamber 18, and laser 16, is directed onto at least a portion of the powder, fusing those powder particles together to form a portion of a sintered material. Successive layers of the powder are distributed onto the surface, and the laser sintering process continues, fusing both the particles of the powdered material together into layers and the adjacent layers together, until the fused layers of laser sintered material are of a shape and thickness as appropriate for the intended use of the material.

Through laser sintering of polymer materials, integral internal features may be incorporated into structures that heretofore have been impossible to attain, including, but not limited to complex shapes and integrated external features that replace the above described stiffening angled clips and ribs. Although laser sintering has been described, other layer build methodologies are contemplated.

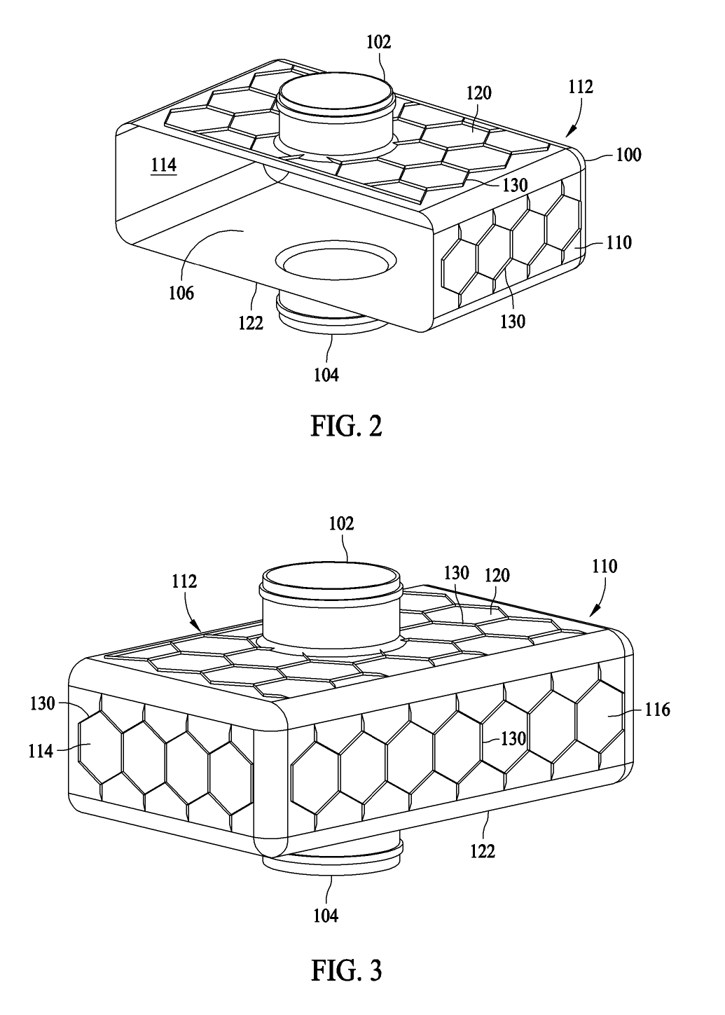

FIG. 2 is a cutaway view illustration of one embodiment of a structure, an air plenum 100, that is fabricated utilizing the system 10 of FIG. 1. For reference, air plenum includes an air inlet 102, an air outlet 104, and a chamber 106 in between. Chamber 106 is substantially rectangular and is defined by four side walls 110, 112, 114, and 116 (shown in FIG. 3). Chamber 106 is further defined by a top wall 120 and a bottom wall 122, which are described as “top” and “bottom” respectively for reference only.

FIG. 3 is a perspective view of air plenum 100 that includes side wall 116. As illustrated by FIGS. 2 and 3, side walls 110, 112, 114, and 116 intersect top and bottom walls 120 and 122 to form the chamber 106 (shown in FIG. 2). The six walls have a have a minimum thickness, in the illustrated embodiment, of about 0.030 inch, but are stiffened by integral raised ridges 130 or bosses in a shape and size (thickness and height) commensurate with a load the walls have to resist during use, for example, from an air pressure within the plenum 100. Specifically in the illustrated embodiment, raised ridges 130 are incorporated in a honeycomb or hexagonal shape. The shape of raised ridges 130 also aid in resisting torque within the walls defining chamber 106 resulting in a stiff structure for air plenum 100.

With regard to SLS, fabrication of air plenum 100 is accomplished in successive layers being “sintered” together. Assuming the plenum 100 is fabricated from the bottom up, the sintering compound would be distributed in a circular pattern within build chamber 18 (shown in FIG. 1). As the circular distribution of sintering compound and successive sintering continues air outlet 104 is formed. As air outlet 104 is completed, the sintering compound is distributed in the honeycomb pattern to begin fabrication of the raised ridges 130 adjacent bottom wall 122 and so on until the raised ridges 130 are complete and fabrication of the solid portion of bottom wall 122 begins. The process continues and successive layers are built up until fabrication of the plenum 100 is complete. It should be noted that air plenum 100 could be fabricated in any “direction” including from top to bottom, from front to back, or from back to front, depending on the dimensions of air plenum 100 and the dimensions of build chamber 18.

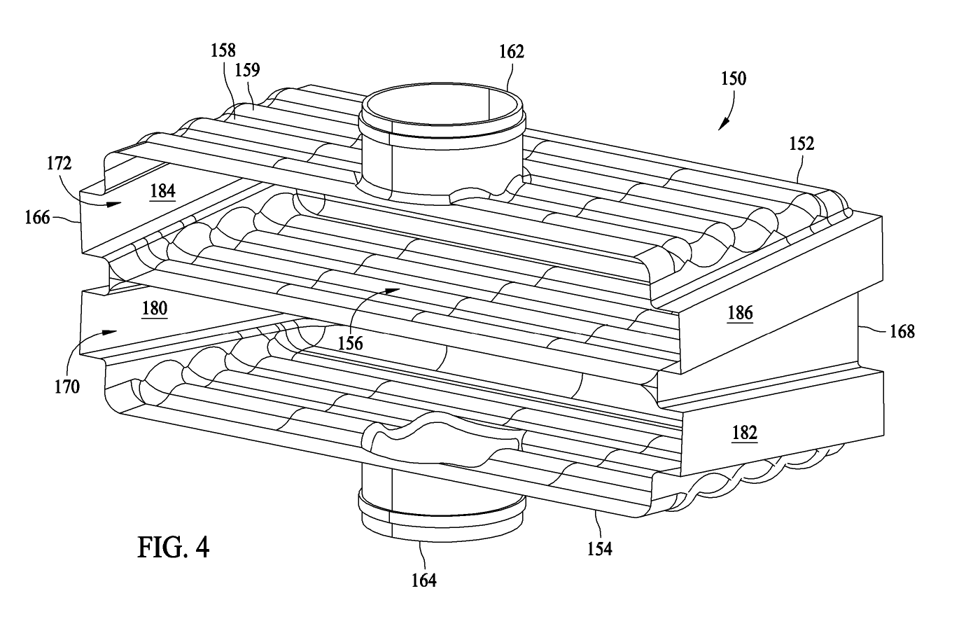

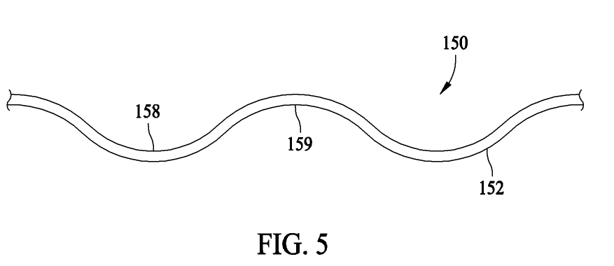

FIG. 4 is a cutaway view illustration of a baffled air plenum 150. Air plenum 150 includes a top wall 152, a bottom wall 154, and a baffling wall 156 substantially centrally located within plenum 150. Air plenum 150 is fabricated utilizing the same processes as air plenum 100 (shown in FIGS. 2 and 3). Rather than incorporating the raised ridges 130 described with respect to air plenum 100, the walls 152, 154, and 156 of air plenum 150 have been fabricated to have a corrugated shape utilizing single opposing arches. FIG. 5 is a cross-section of a portion of wall 152, for example, illustrating the single opposing arches, for example, arches 158 and 159. It is to be understood that the cross-section of FIG. 5 is also illustrative of the cross sections of walls 154 and 156.

Referring back to FIG. 4, air plenum 150 includes an air inlet 162, an air outlet 164, and sides 166 and 168. A front wall is not shown so that the detail of the chambers 170 and 172 can be illustrated. Similar to the walls of air plenum 100, walls 152, 154, and 156 have a minimum thickness of about 0.030 inch, but are stiffened by utilization of the single opposing arch configuration. The arches 158 and 159 are shaped and sized (width and height of each arch) commensurate with a load the walls 152, 154, and 156 have to withstand during use, for example, from an air pressure within the plenum 150.

When fabricated utilizing the selective laser sintering process, individual layers of the sintering compound are serially subjected to the laser to “build up” the air plenum 150. In one example, layers of sintering compound are built up to fabricate air outlet 164, the arches of bottom wall 154, a bottom portion 180 and 182 of respective sides 166 and 168, the arches of baffling wall 156, a top portion 184 and 186 of respective sides 166 and 168, the arches of top wall 152, and air inlet 162. It should be noted that air plenum 150 could be fabricated in any “direction” including from top to bottom, from front to back, or from back to front, depending on the dimensions of air plenum 100 and the dimensions of build chamber 18.

It should also be noted that in the illustrated embodiment, air plenum 150 is overall slightly wedge-shaped, as best illustrated by the overall shape of side 168. With respect to baffling wall 156, the wedge shape may be obtained by either fabricating baffling wall 156 to be thicker from a front to a back (as illustrated) of air plenum 150, or by fabricating baffling wall 156 as two gradually separating corrugated structures.

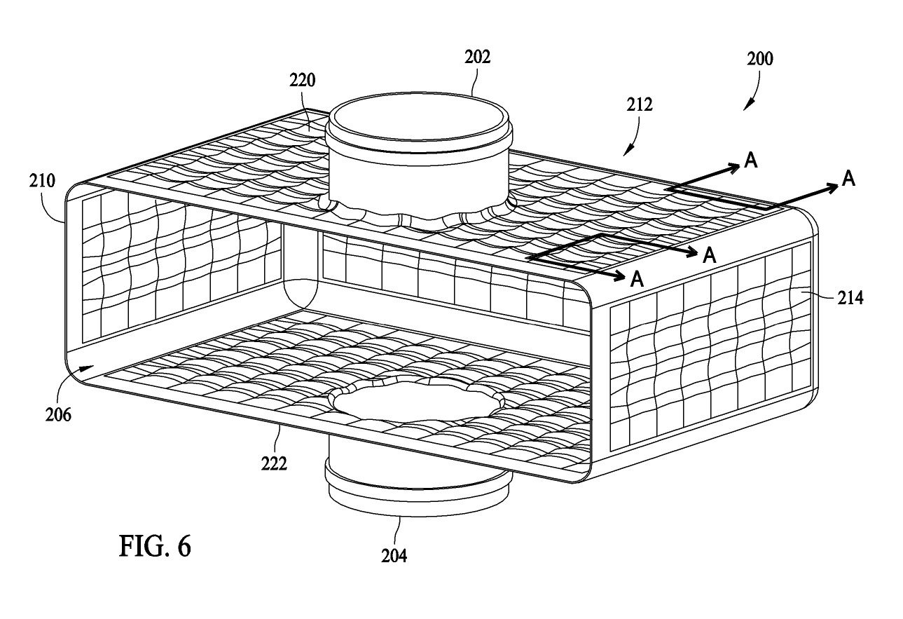

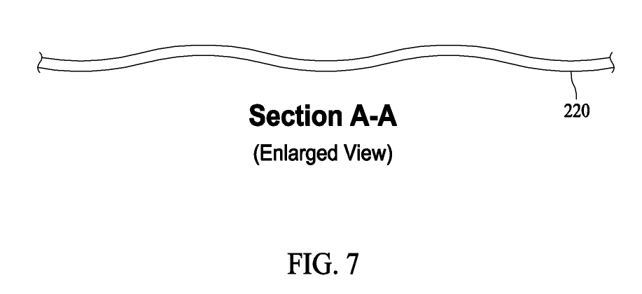

FIG. 6 is a cutaway view illustration of an another embodiment of an air plenum 200. Air plenum 200 includes an air inlet 202, an air outlet 204, and a chamber 206 in between. Chamber 206 is substantially rectangular and is defined by four side walls 210, 212, 214, and a fourth side wall that is not shown due to the cutaway view. Chamber 206 is further defined by a top wall 220 and a bottom wall 222, which are described as “top” and “bottom” respectively for reference only. Air plenum 200 is fabricated utilizing the same processes as air plenum 100 (shown in FIGS. 2 and 3). Rather than incorporating the raised ridges 130 described with respect to air plenum 100, the walls 210, 212, 214, and the fourth wall of air plenum 200 have been fabricated to have a waffle-pattern shape utilizing double opposing arches. FIG. 7 is a cross-sectional view of a portion of top wall 220, for example, in a first direction as viewed from the direction of wall 214 illustrating single opposing arches. The cross-section is the same when viewed from the direction of wall 212. It is to be understood that the cross-section of FIG. 7 is also illustrative of the cross sections of walls 210, 212, 214, 222, and the non-illustrated wall.

Therefore, as utilized herein, double opposing arches refers to a configuration as a first set of singles opposing arches in a first direction and a second set of single opposing arches in a second direction substantially perpendicular to the first direction. Such double opposing arches tend to tend to create a quilted pattern as illustrated in FIG. 6.

Referring back to FIG. 6, a front wall is not shown so that the detail of the chamber 206, and specifically the walls that form the chamber can be better illustrated. Similar to the walls of air plenums 100 and 150, walls 210, 212, and 214, top wall 220, bottom wall 222, and the non-illustrated wall have a minimum thickness of about 0.030 inch, but are stiffened by utilization of the double opposing arch configuration. The arches are shaped and sized in each direction (width and height of each arch) commensurate with a load the walls 210, 212, and 214, top wall 220, bottom wall 222, and the non-illustrated wall have to withstand during use, for example, from an air pressure within the plenum 200.

When fabricated utilizing the selective laser sintering process, individual layers of the sintering compound are serially subjected to the laser to “build up” the air plenum 200 as previously described with respect to air plenums 100 and 150 and the dimensions of build chamber 18.

The arch shape (both single opposing and double opposing) and the honeycomb shape have inherent compression properties. By taking advantage of these properties, wall thicknesses can be reduced in panels, without reducing strength properties. Such configuration also reduce overall weight of structures that incorporate such walls. Utilization of the herein described arch shapes and/or honeycomb configurations provide stiffening for the relatively thin wall panels. The thickness and height of the raised hexagonal ridge, or boss, in the honeycomb configuration is tailored to resist the pressure loads being applied within the structure. Similarly, the widths and heights of the opposing arches (single and double) are tailored to resist the pressure loads being applied within the structure.

In addition, the description herein demonstrate how these shapes can be integrally fabricated into a structure, for example, an air handling plenum, to stiffen the thin wall structure from buckling and collapsing with integral torque stiffness. These shapes also aid in resisting torque within the box resulting in a stiff structure.

While the invention has been described in terms of various specific embodiments, those skilled in the art will recognize that the invention can be practiced with modification within the spirit and scope of the claims.

What is claimed is:

1. A method for manufacturing a wall of a thin-walled structure, said method comprising:
receiving parameters for the wall and one or more stiffening features associated with the wall via a user interface;
providing the parameters to a machine configured to fabricate the wall and incorporate the one or more stiffening features, the machine using a direct manufacturing process; and
operating the machine to integrally fabricate the wall and the one or more stiffening features.

2. A method according to claim 1 wherein operating the machine to integrally fabricate comprises utilizing selective laser sintering to integrally fabricate the wall and the one or more stiffening features.

3. A method according to claim 1 wherein describing parameters for the wall and one or more stiffening features comprises defining a thickness for the wall and a raised ridge pattern to be formed integrally with the wall.

4. A method according to claim 3 wherein defining raised ridges to be formed integrally with the wall comprises defining a honeycombed-shaped pattern of raised ridges to be formed integrally with the wall.

5. A method according to claim 1 wherein describing parameters for the wall and one or more stiffening features comprises defining the wall to include a plurality of single opposing arches.

6. A method according to claim 1 wherein describing parameters for the wall and one or more stiffening features comprises defining the wall to include a first plurality of single opposing arches and a second plurality of single opposing arches, the first plurality and the second plurality substantially perpendicular to one another.

7. A method according to claim 1 wherein describing parameters for the wall and one or more stiffening features comprises defining the one or more stiffening features to resist an anticipated pressure load for the wall.

8. An air handling aerospace structure comprising:
a plurality of walls defining a chamber; and
at least one stiffening feature formed integrally with at least one of said walls, said walls and said at least one stiffening feature fabricated utilizing a direct manufacturing process.

9. An air handling aerospace structure according to claim 8 wherein said at least one wall and said at least one stiffening feature are integrally formed using a selective laser sintering process.

10. An air handling aerospace structure according to claim 8 wherein said at least one stiffening feature comprises raised ridges formed integrally with said at least one wall.

11. An air handling aerospace structure according to claim 10 wherein said raised ridges comprise a honeycombed-shaped pattern of raised ridges to be formed integrally with said at least one wall.

12. An air handling aerospace structure according to claim 8 wherein said at least one wall and said at least one stiffening feature comprise a plurality of single opposing arches.

13. An air handling aerospace structure according to claim 8 wherein said at least one wall and said at least one stiffening feature comprise a first plurality of single opposing arches and a second plurality of single opposing arches, the first plurality and the second plurality substantially perpendicular to one another.

14. An air handling aerospace structure according to claim 8 wherein the direct manufacturing process comprises a single build run executed on a build chamber utilizing a selective laser sintering process.

15. A method for direct manufacturing a structure having at least one substantially enclosed chamber defined by a plurality of walls, said method comprising:
defining, for input into the direct manufacturing process, the plurality of walls, a stiffening feature for at least one of the walls, and a remainder of the structure; and
integrally forming the walls, any stiffening feature associated with each respective wall, and the remainder of the structure, with the direct manufacturing process.

16. A method according to claim 15 wherein integrally forming comprises fabricating the walls, any stiffening feature, and the remainder of the structure, utilizing a selective laser sintering process.

17. A method according to claim 15 wherein defining the plurality of walls and a stiffening feature for at least one of the walls comprises at least one of defining a honeycombed-shaped pattern of raised ridges to be formed integrally with at least one of the walls, defining at least one of the walls to include a plurality of single opposing arches, and defining at least one of the walls to include a first plurality of single opposing arches and a second plurality of single opposing arches, the first plurality and the second plurality substantially perpendicular to one another.

18. A method according to claim 15 wherein the thin-walled structure is an air plenum and wherein defining the plurality of walls and a stiffening feature for at least one of the walls comprises:
defining parameters for fabricating an air inlet to the air plenum using a selective laser sintering process;
defining parameters for fabricating a first wall for the air plenum that is substantially perpendicular to and extending from the air inlet using a selective laser sintering process;
defining parameters for fabricating a plurality of side walls for the air plenum, first ends of the side walls substantially perpendicular to and extending from a perimeter of the first wall using a selective laser sintering process;
defining parameters for fabricating a second wall for the air plenum that is substantially perpendicular to and extending from a second end of the plurality of side walls using a selective laser sintering process;
defining parameters for fabricating an air outlet from the air plenum that is substantially perpendicular to and extending from the second wall using a selective laser sintering process; and
defining parameters for at least one of the side walls, the first wall and the second walls to include a stiffening feature integrally formed therewith.

19. A method according to claim 18 wherein the stiffening feature comprises at least one of a honeycombed-shaped pattern of raised ridge, a plurality of single opposing arches, and a first plurality of single opposing arches and a second plurality of single opposing arches, the first plurality and the second plurality substantially perpendicular to one another.

20. A method according to claim 19 further comprising defining parameters for fabricating a baffling wall for the air plenum that is substantially perpendicular to and extending from the plurality of side walls, between the first end and the second end of the side walls, using a selective laser sintering process.

21. A method according to claim 20 wherein defining parameters for fabricating a baffling wall for the air plenum comprises defining the baffling wall to include a stiffening feature integrally formed therewith, the stiffening feature comprising at least one of a honeycombed-shaped pattern of raised ridge, a plurality of single opposing arches, and a first plurality of single opposing arches and a second plurality of single opposing arches, the first plurality and the second plurality substantially perpendicular to one another.
